(19) United States
(12) Patent Application Publication
(10) Pub. No.: US 2026/0254742 A1
(43) Pub. Date: Aug. 27, 2026

(54) ERROR DETECTION FOR HYDROCARBON PRODUCTION SYSTEMS

(71) Applicant: Halliburton Energy Services, Inc., Houston, TX (US)

(72) Inventor: Andreas Sadlier, Houston, TX (US)

(21) Appl. No.: 19/355,598

(22) Filed: Oct. 10, 2025

Related U.S. Application Data
(60) Provisional application No. 63/764,261, filed on Feb. 27, 2025.

(51) Int. Cl. H04L 43/0876; G05B 23/02

(52) U.S. Cl. CPC H04L 43/0876; G05B 23/0275

(57) ABSTRACT

Some implementations include a method comprising: determining a first metric indicating a first statistical property of one or more of a plurality of data streams that include information about a hydrocarbon production system; determining a second metric indicating a second statistical property of one or more of the plurality of data streams; using the first metric or the second metric to identify a malfunctioning component in the hydrocarbon production system ; and physically modifying the component of the hydrocarbon production system using at least one of the frequency metric and the value metric.

### TECHNICAL FIELD

Some implementations relate to hydrocarbon production systems. More specifically, some implementations relate to system and methods for error detection for hydrocarbon production systems.

### BACKGROUND

In oil and gas drilling, real-time data is crucial for effective remote operations, making data quality control a critical issue. Poor data quality can lead to incorrect analysis and a breakdown in trust between rig and remote operations personnel. The increasing prevalence of data analytics, machine learning, and automation further emphasizes the importance of maintaining real-time data service quality.

The sheer volume of data generated by modern systems makes traditional manual quality checks impractical (some systems monitoring over 30,000 tags/sensors and producing millions of data points daily). This may make some automated anomaly detection models more attractive. Some traditional systems may focus on using first principal calculations and rules as basic Key Performance Indicators (KPIs). These KPIs may include checks for ISO-formatted timestamps, values within sensible ranges, matching declared and received curve counts, and correct units of measure. However, the complexity of these checks—six scoring dimensions and 241 business rules—makes them difficult to maintain. A statistical approach to real-time data Quality Assurance and Quality Control (QAQC) algorithms for streaming data is lacking.

### BRIEF DESCRIPTION OF THE DRAWINGS

Implementations of the disclosure may be better understood by referencing the accompanying drawings.

FIG. 1 is a diagram illustrating a user interface presented by a real-time data quality tool.

FIG. 2 is a chart including graphs showing the normalized start times and calibrated elapsed times for the ten curves.

FIG. 3 is a chart including graphs showing latency distributions for average log curves.

FIG. 4 is a chart including graphs showing the median, median absolute deviation (MAD), and interquartile range (IQR) for log curves.

FIGS. 5, 6, 7, and 8 each include four graphs for rigs A, B, C, and D, respectively.

FIGS. 9 and 10 illustrate the impact of five-minute and half-minute window sizes.

FIGS. 11 and 12 show the results for Rig D with the same window sizes.

FIG. 13 is a block diagram illustrating a computer system configured to determine statistical metrics from well communications and facilitate corrective actions.

FIG. 14 is a schematic diagram of a drilling system.

FIG. 15 is a flow diagram illustrating a method for monitoring real-time data and taking corrective action to remedy problems in a hydrocarbon production system.

### DESCRIPTION OF IMPLEMENTATIONS

The description that follows may include example systems, methods, techniques, and program flows that embody implementations of the disclosure. However, this disclosure may be practiced without these specific details. For clarity, some well-known instruction instances, protocols, structures, and techniques may not be shown in detail.

### Overview

Systems for producing hydrocarbons may include numerous systems and equipment such as communication systems, data processing systems, control systems, drilling equipment, hydraulic fracturing equipment, production equipment, and more. Monitoring real-time data across the systems and equipment may enable operators to quickly identify problems and take remedial action to address the problems. Some implementations compute statistical metrics for system data (such as logs) in real time and respond to statistical anomalies with corrective action. In some implementations, such corrective action may include physically modifying equipment such as by replacing downhole sensors, modifying drill speed/pressure/etc., modifying communication intervals/frequencies/etc., and many others. Some implementations may also monitor worksite states (such as states of a drilling rig) to better interpret the statistical metrics and/or to select between alternative corrective measures. For example, for a drilling process, some implementations may detect long latencies in communications from drilling equipment but may choose to ignore the latencies during trip-out of the drill bit. However, during drilling, some implementations may response by replacing downhole sensors.

Traditional approaches may lack a statistical approach to real-time data Quality Assurance and Quality Control (QAQC) for streaming data. This gap is particularly apparent when adapting traditional approaches to different drilling operations, diverse rig-to-office network topologies, or varying processes between third-party service providers. Adapting traditional approaches to different drilling operations may be especially challenging given the absence of a universally precise Key Performance Indicators (KPIs) for measuring real-time streaming service quality, such as data latency or completeness. Hence, some implementations utilize continuous z-score error detection for real-time data quality assurance in remote drilling operations.

Some implementations may monitor and determine z-score statistics for streaming communications in Wellsite Information Transfer Standard Markup Language (WITSML) over the Energistics Transfer Protocol (ETP). Some implementations may utilize a five-minute sliding window for z-score latency calculations. Some implementations also may utilize the z-score to determine a Latency Variability Index (LVI) and a Curve Variability Index (CVI) (described in more detail below). Some implementations may use LVI and CVI to detect problems with systems and/or equipment. In response to these problems, some implementations may take corrective action. By providing real-time insights into data anomalies, Z-score modelling may contribute to increased productivity and assist engineers in remote operations.

### Example Implementations

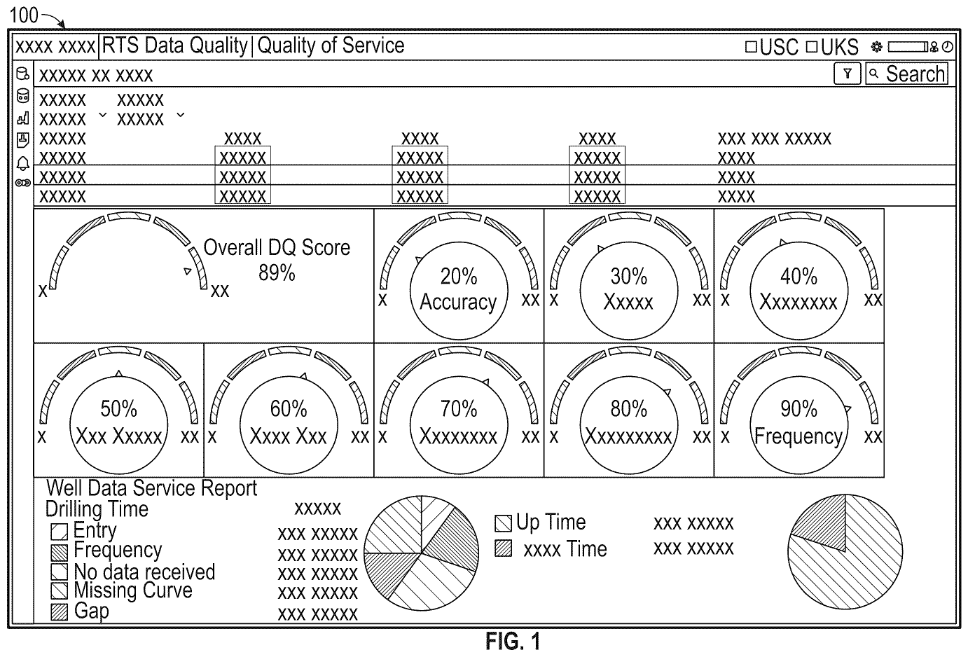

Wellsite Information Transfer Standard Markup Language (WITSML), an Energistics standard, may be used for exchanging drilling and well operations data. WITSML may ensure interoperability between systems and service providers through a structured format for real-time data and logs. Drilling data quality may facilitate effective real-time monitoring, analysis, and decision-making. Real-time data quality may be evaluated using several key performance indicators (KPIs) across multiple dimensions. These dimensions may include Completeness, Uniqueness, Timeliness, Integrity, Accuracy (or Sensibility), and Consistency. These dimensions may assess whether data is complete, free of duplicates, delivered on time, formatted correctly, within expected ranges, and logically consistent. FIG. 1 is a diagram illustrating a user interface presented by a real-time data quality tool. In FIG. 1, the user interface 100 includes a value for each of these dimensions.

The Energistics Transfer Protocol (ETP), a WebSocket-based protocol, may enable efficient, reliable, real-time WITSML data streaming from drilling rigs to onshore operating centers. While traditional data quality dimensions remain relevant, ETP's streaming nature may entail a nuanced view of Timeliness and Completeness. For WITSML over ETP, Completeness means uninterrupted data flow; gaps or delays in even one curve constitute incomplete information and a delivery rate failure. Similarly, Timeliness is tied to Completeness: latency in any channel signifies failure in both dimensions—data is both missing and late. Thus, continuous, timely delivery of all channels may facilitate real-time decisions, making anomaly detection using ETP helpful for ensuring both Timeliness and Completeness.

Outliers, or data points that deviate significantly from the norm, are a common challenge in real-time drilling data. Outlier detection methods, including Z-score/Extreme Value Analysis, Interquartile Range (IQR), and machine learning-based approaches. Z-score offer a practical method for monitoring real-time data quality. Outlier detection methods may measure how many standard deviations a particular data point is from the mean of the dataset. Equation 1 shows a formula for determining z-score.

z=(x−μ)/σ (1)
Where: z is the z-score; x is the individual data point for analysis; μis the mean of the dataset; and σ is the standard deviation of the dataset.

Z-scores may be used for efficiently monitoring real-time data streams for anomalies by establishing a baseline mean (μ) and standard deviation (σ) during normal operation. Incoming data points' z-scores may be calculated against this baseline (e.g., a five-minute sliding window). High absolute z-scores (e.g., >3) may indicate potential anomalies that indicate deviations from the norm (such as sensor malfunctions, network latency, etc.). Z-scores may standardize data across sensors, logs, and time periods, facilitating comparison and enable threshold-based (e.g., ±2 or ±3) anomaly detection for immediate investigation. For example, if an average latency is 2.5 seconds (σ=0.5 s), a 3.75-second latency has a z-score of 2.5, potentially triggering an alert. This approach enables robust, adaptable real-time data quality monitoring across diverse operating conditions by detecting relative deviations rather than absolute thresholds.

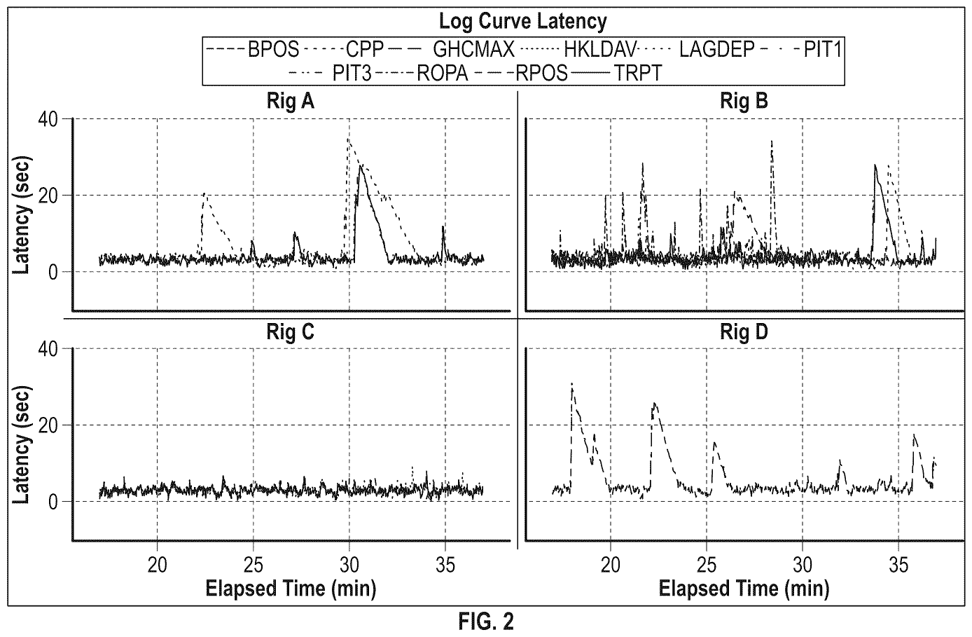

Some implementations may capture surface logs (such as at 1-second frequency, over several hours) via ETP from four active rigs (labeled A, B, C, D). As an example, ten common curve mnemonics (BPOS, CPP, GHCMAX, HKLDAV, LAGDEP, PIT1, PIT3, ROPA, RPOS, TRPT) may be selected for analysis. Each of the curves may include information collected by particular components such as downhole pressure sensors, gamma ray sensors, drill bit sensors, downhole tools, surface-based systems, and/or any suitable components in a hydrocarbon production system. Start times may be normalized, elapsed times calibrated (minutes, t=0), and average latency (across all curves, per rig) may be calculated per second. FIG. 2 is a chart including graphs showing the normalized start times and calibrated elapsed times for the ten curves. The calculated average latency values are not shown in FIG. 2. The logs may be initially acquired from completely independent rig systems operating concurrently. Some implementations may stream these logs into a central, multi-tenant cloud-based aggregation system using a hub-and-spoke architecture. This centralized aggregation approach, with data originating from disparate sources and potentially facing varying network conditions before reaching the cloud, could significantly influence the observed latency patterns and overall data quality.

Some implementations utilize a five-minute sliding window for z-score latency calculations. To assess the Timeliness and Completeness dimensions of real-time ETP data quality, some implementations may utilize two new parameters: the Latency Variability Index (LVI) and the Curve Variability Index (CVI), respectively. Both LVI and CVI may be calculated independently at each 1-second log interval, using the same five-minute sliding window.

The LVI may emphasize systemic latency deviations of all curves together. Equation 2 shows a formula for computing LVI.

LVI=Zavg/(SD+0.001) (2)
In equation 2, ZAvg is the z-score of the average latency, across all curves. SD is the standard deviation of the individual curve z-scores. The 0.001 constant, determined empirically, magnifies LVI when curve z-scores are similar (SD≈0). LVI may be set to 0 if negative or undefined.

The CVI highlights relative differences in z-scores across curves. Equation 3 shows a formula for computing LVI.

CVI=Diff/(SD+0.001) (3)
In equation 3, Diff is the difference between the maximum and minimum individual z-scores. Both indices may use the same SD calculated over the sliding window size, providing complementary perspectives on data quality by considering both overall latency trends and individual curve variations.

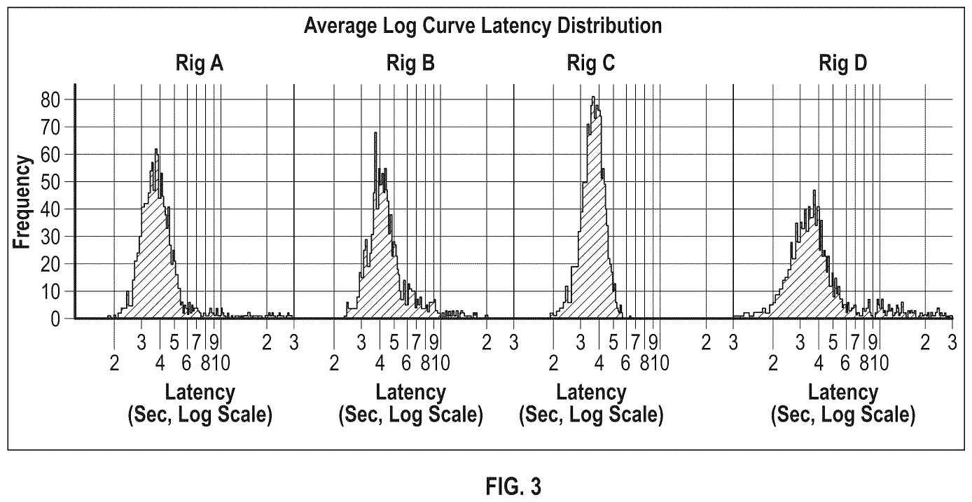

FIG. 3 is a chart including graphs showing latency distributions for average log curves. In this example, the distribution of latency for each rig (rigs A, B, C, and D) varied, showing a mix of tightly bound and right-skewed patterns, which is expected given that latency cannot be negative (see FIG. 3).

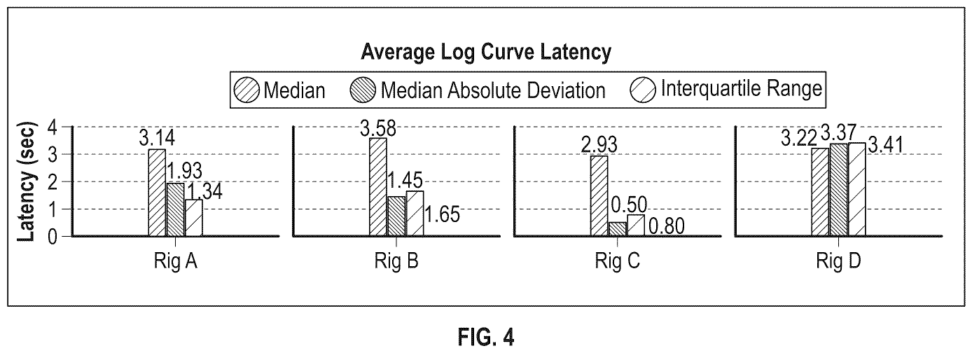

FIG. 4 is a chart including graphs showing the median, median absolute deviation (MAD), and interquartile range (IQR) for log curves. For skewed distributions, non-parametric measures like the median, MAD, and IQR may be more representative than the average and standard deviation. The median, the middle value in a sorted dataset, may be less affected by outliers. The MAD, calculated as the median of the absolute deviations from the median, may also be robust to outliers. The IQR, the range between the 25th and 75th percentiles, may provide a measure of spread that is similarly resistant to extreme values.

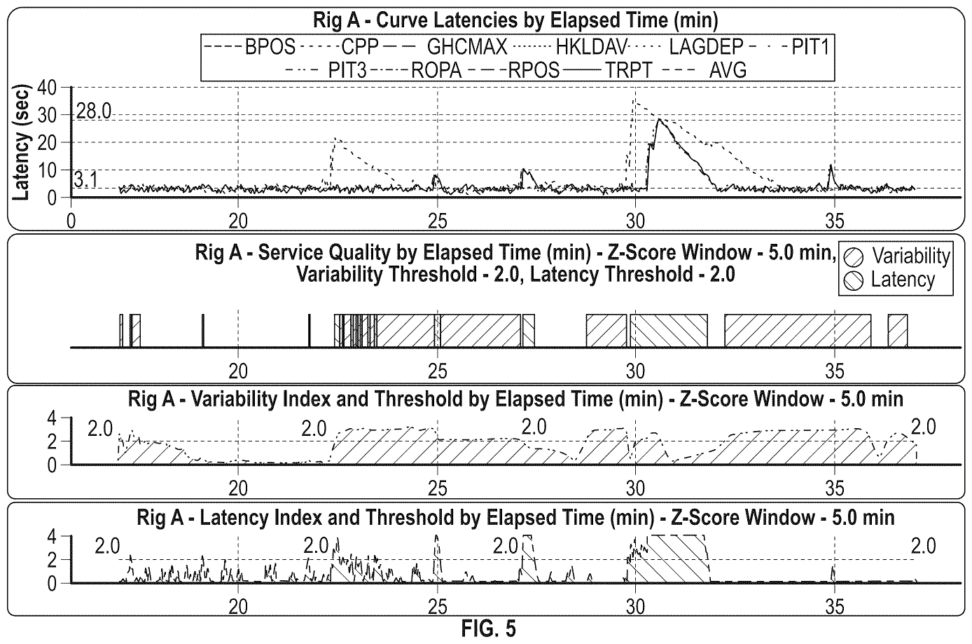

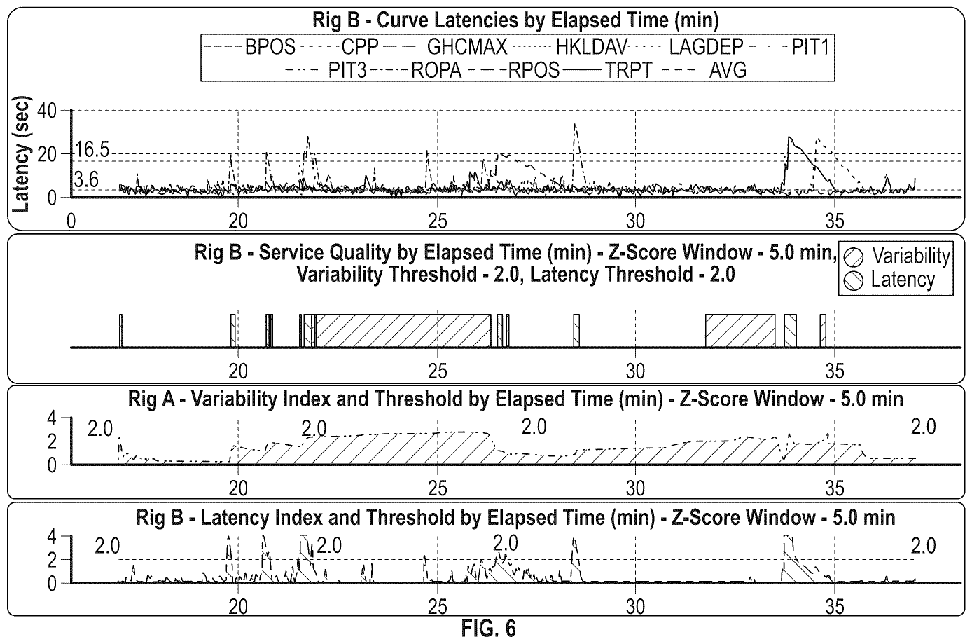

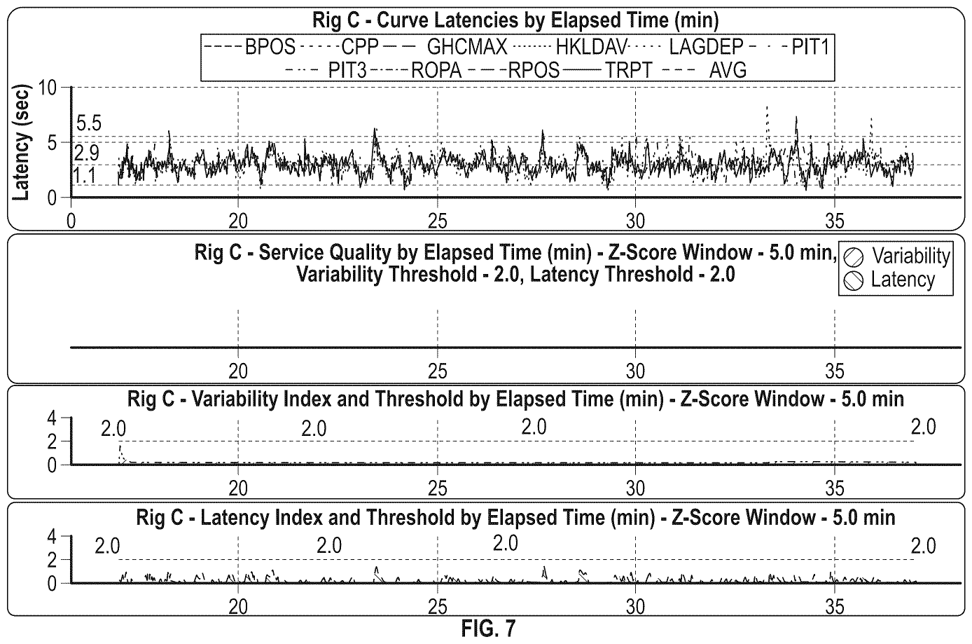

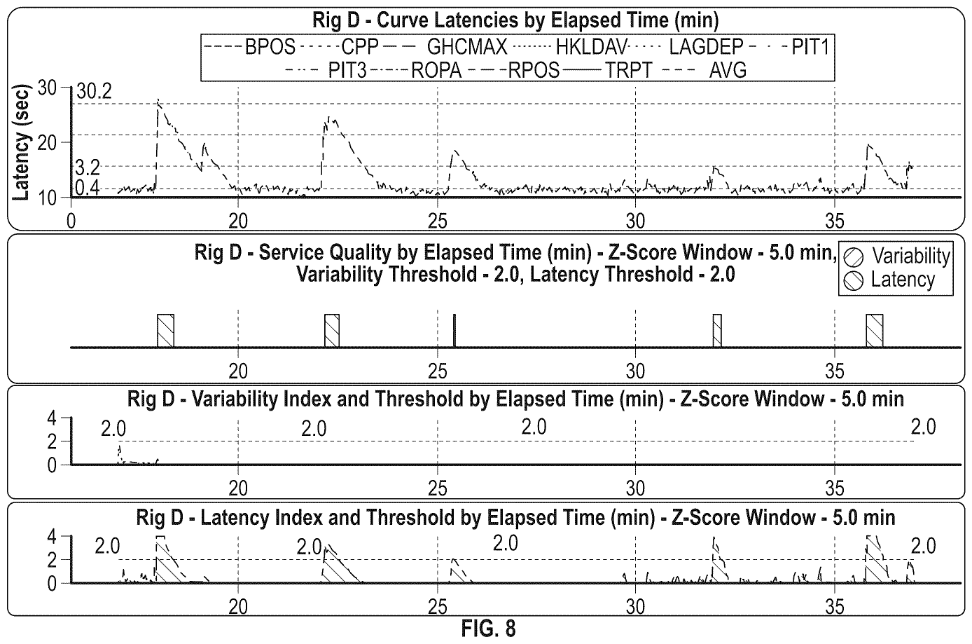

To analyze the performance of the LVI and CVI, some implementations may examine a similar region of interest in the elapsed time for each of the example four rigs, setting the initial window size to five minutes (300 1-second data points). FIGS. 5, 6, 7, and 8 each include four graphs for rigs A, B, C, and D, respectively, with synchronized elapsed time on the horizontal axis. Each Figure includes: 1) Individual Log Curve Latencies that visualizes the latency of each of the ten log curves; 2) Service Quality Strip Chart that indicates variability (yellow) or latency (red) alarms (1 or 0) based on CVI and LVI thresholds; 3) Curve Variability Index (CVI) that plots the CVI with an adjustable threshold for triggering variability alarms; and 4) Latency Variability Index (LVI) that plots the LVI with an adjustable threshold for triggering latency alarms. FIGS. 5-8 show a comparison of CVI and LVI against the raw latency data and observe how the indices respond to different latency patterns. The adjustable thresholds in the CVI and LVI graphs demonstrate how some implementations may tune these parameters to control the sensitivity of the alarm system.

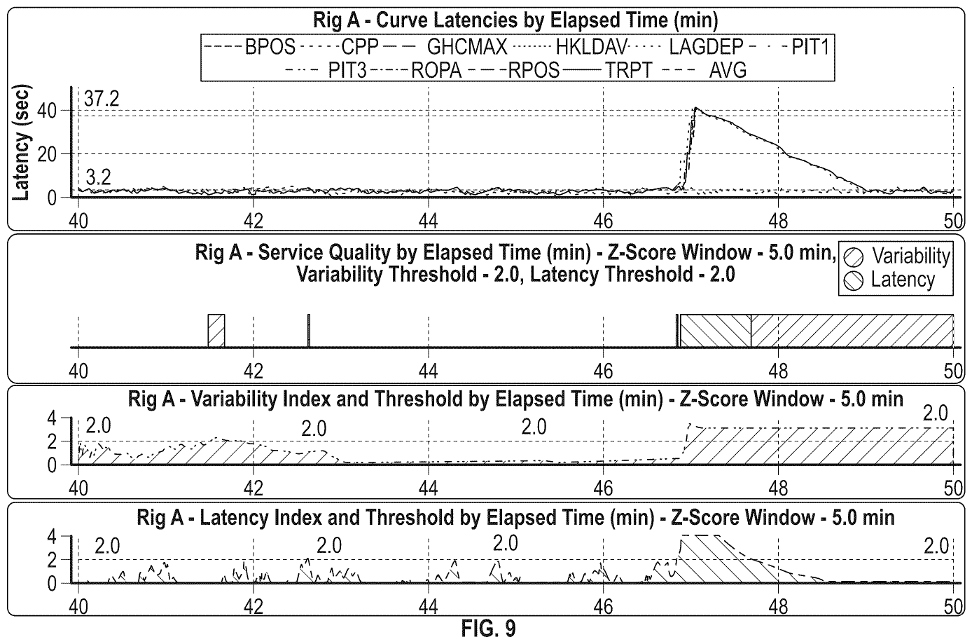

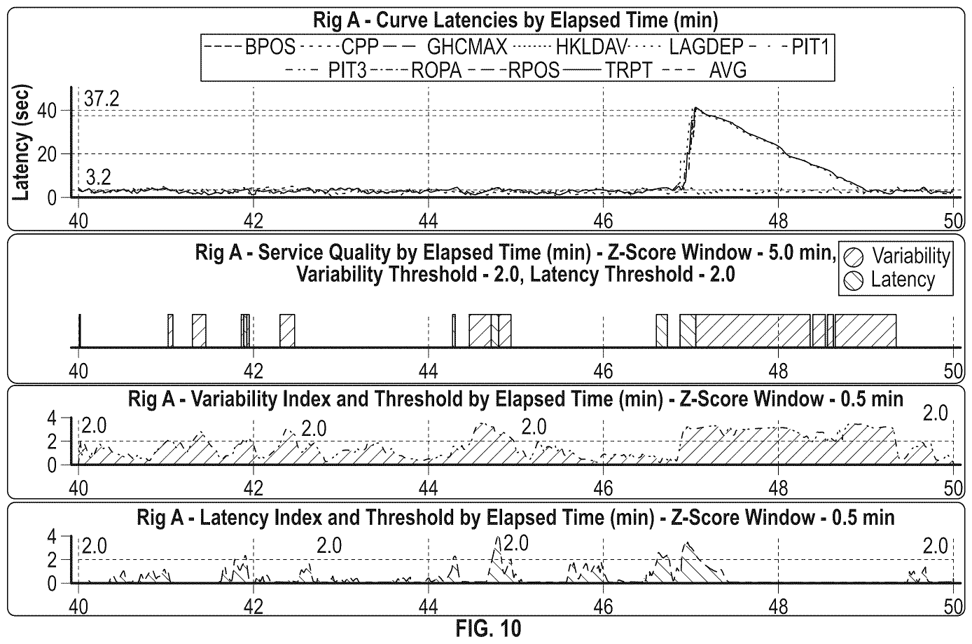

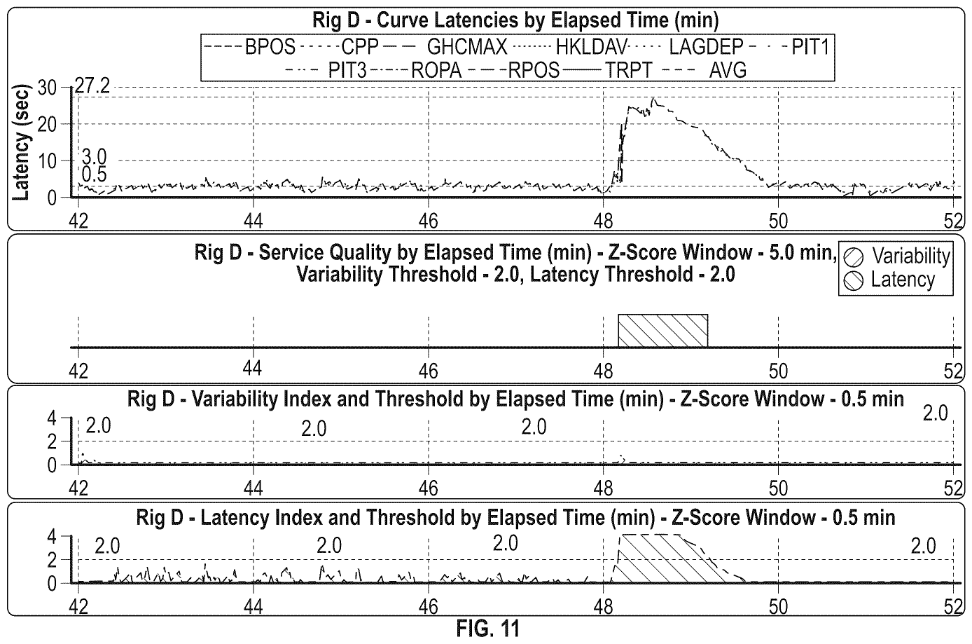

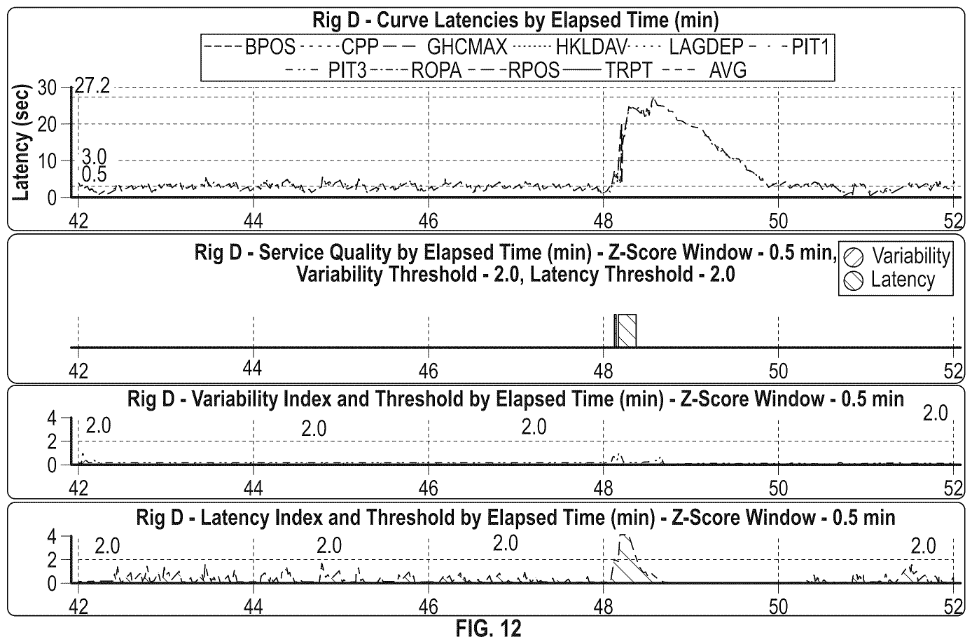

The sliding Z-score window size may affect the calculated CVI, LVI, and consequently, the Service Quality metric. FIGS. 9 and 10 illustrate the impact of five-minute (300, 1-second historical data points) and half-minute (30, 1-second historical data points) window sizes, respectively, on Rig A. Similarly, FIGS. 11 and 12 show the results for Rig D with the same window sizes. Hence, some implementations may use different z-score window sizes for different situations.

Some implementations use Z-scores for variable data like latency, which may differ significantly between rigs and even among logs from the same rig. Rather than using fixed thresholds, z-scores may normalize latency data to each rig's average, highlighting deviations from that rig's typical performance. For Timeliness, a consistently high LVI may indicate a systematic delay across all curves in a channel set. Such a delay could stem from rig-to-office connectivity issues, network congestion, or problems with the stability of the real-time data aggregation system. For Completeness, a high CVI may indicate latency in individual or a subset of curves in the log. This pattern suggests data loss or interruption in those channels, and the cause may be an issue originating from the rig, such as sensor malfunctions, configuration errors, or other operational problems. Similarly, frequency interval z-scores may identify anomalous variability in individual curves that deviate from their expected streaming frequency. Some implementations may use frequency metrics that are computed using frequency interval z-scores. For example, some implementations may compute frequency metrics using frequency interval z-scores in a manner similar to LVI and CVI. This may help detect issues such as a 1-second interval suddenly being sent only every 5 seconds, which may indicate a problem with data acquisition or configuration. Some implementations may use value metrics to detect anomalous variability in data steams. For example, in some implementations, the value would be an actual measurement (unitless) which may be compared to an average of all values in the log vs. individual values of each sensor. Some implementations may compute value metrics using z-scores in a manner similar to LVI and CVI.

The choice of window size in z-score calculations may impact real-time data quality monitoring during drilling operations. Smaller window sizes may increase sensitivity to short-term fluctuations, enabling faster anomaly detection. However, this heightened sensitivity may also lead to an increase in false positives, as transient noise may be misinterpreted as significant deviations. Furthermore, for extended anomalies, a smaller window size may eventually treat the persistent deviation as ‘normal,’ effectively resetting a potential alarm condition and hindering further detection. Conversely, larger window sizes (such as by averaging over longer periods) may favor overall trends and reduce sensitivity to short-term fluctuations. This may decrease false positives but may delay the detection of actual anomalies, potentially hindering timely intervention.

In addition to potentially delaying anomaly detection, larger window sizes may increase computational cost, as each z-score calculation may involve more data points. For continuous real-time monitoring, where computational resources might be limited, a trade-off may exist between accuracy (often improved with larger windows) and computational efficiency. Z-score sliding window batching offers a way to mitigate this trade-off. By calculating a new z-score only after a batch of new data points arrives (e.g., 5 data points), instead of for every 1-second data point, the computational load may be reduced without drastically sacrificing accuracy.

In addition to window size and batching, adjusting the LVI and CVI thresholds may fine-tune the sensitivity of service quality alarms. Higher thresholds may make the system less sensitive to minor fluctuations, reducing false alarms but potentially missing some true anomalies. Lower thresholds may increase sensitivity, leading to earlier detection but potentially more false positives. The optimal threshold values may depend on the specific application and the desired balance between sensitivity and specificity. In some implementations, a value of 2 for both LVI and CVI may be appropriate, striking a balance between timely anomaly detection and minimizing false positives. This threshold may effectively send alarms on relatively severe deviations while filtering out transient noise.

Rig-state detection, the ability to identify the drilling rig's current activity (e.g., drilling, tripping), is also important for accurately interpreting real-time data quality. By integrating rig-state information with z-score calculations, we can dynamically prioritize which sensor data is most relevant, ensuring that anomaly detection focuses on the parameters that truly matter for the ongoing operation. For example, while drilling, downhole tool data may be paramount, and the z-score detection system should focus on those curves. In contrast, during tripping operations, surface sensor data may become more significant.

While rig-state detection may enhance the accuracy of the analysis, the rig-state information itself may be subject to data quality issues or latency. Hence, some implementations include robust rig-state detection mechanisms to ensure the reliability of the overall system.

Rig-state detection may allow the system to automatically shift its focus, adapt thresholds, and avoid false alarms, as expected fluctuations during different rig states can vary widely. Without rig-state awareness, data quality assessment may be ambiguous. A sudden change in a sensor reading might indicate a true anomaly or simply a normal fluctuation due to a change in rig activity. Integrating rig-state detection may allow for more deterministic data analysis, where the system may understand the context behind the data and can distinguish between expected and unexpected behavior.

The integration of rig-state detection with z-score-based anomaly detection may provide a powerful framework for real-time data quality assurance. This approach not only enhances operational efficiency but also may improve drilling optimization and better supports future AI and automation systems by providing statistically validated data relevant to the rig's current state.

Automated anomaly detection models, such as those employing Z-score modelling, may ensuring real-time data quality and reliability in oil and gas drilling. These models may operate with minimal configuration and adapt to various log curves and drilling environments. Once the window time span is reached (e.g., 5 minutes), the models may normalize to the rig's expected behavior, with sensitivity controlled by the LVI and CVI thresholds and the window size.

Some implementations may take actions to address various conditions that are detected from monitoring LVI and/or CVI for one or more curves. One or more conditions may affect one or more of the curves in the log. For example, network latency may exceed a threshold for multiple curves. In response to an alarm presented by the monitoring and control unit 1306, a network engineer may execute a network failover and verifies data transmission frequency of affected curves if fixed. As another example, a central aggregator may encounter a software error leading to missing data points. In response to an alarm, an IT support technician may restart the service and performs a data integrity check, focusing on the affected curves. As another example, the monitoring and control unit 1306 may detect an out-of-range sensor value detected. In response to an alarm, a data engineer may adjust filtering rules, specifically targeting the curve with the out-of-range value and considering the rig state.

Some issues may relate specifically to a rig, where some but not all curves in the log are affected. For example, the monitoring and control unit 1306 may detect a sensor out-of-range reading, inconsistent with rig state. In response to an alarm from the monitoring and control unit 1306, a rig technician may check the sensor's readings, verify the range, and confirm the sensor's frequency in relation to the current rig state. As another example, the monitoring and control unit 1306 may detect a primary sensor failure, leading to a gap in a critical data curve. In response to an alarm, the rig crew may switch to a redundant sensor and compare data curves with historical data from the failed sensor. As another example, the monitoring and control unit 1306 may detect a data anomaly detected such as a missing curve and/or delayed data points and/or out-of-range values observed during a specific rig state. In response to an alarm, the rig crew investigates the cause, considering sensor malfunctions, configuration errors, or legitimate operational changes within the context of the current rig state. As another example, the monitoring and control unit 1306 may detect a rig acquisition system error impacting data transmission from multiple sensors. In response to an alarm, the rig crew, potentially guided by remote support, may diagnose the issue, which might involve restarting the system, checking connections, or identifying faulty components. They then may verify data flow from all sensors after resolving the problem.

### Example Environment

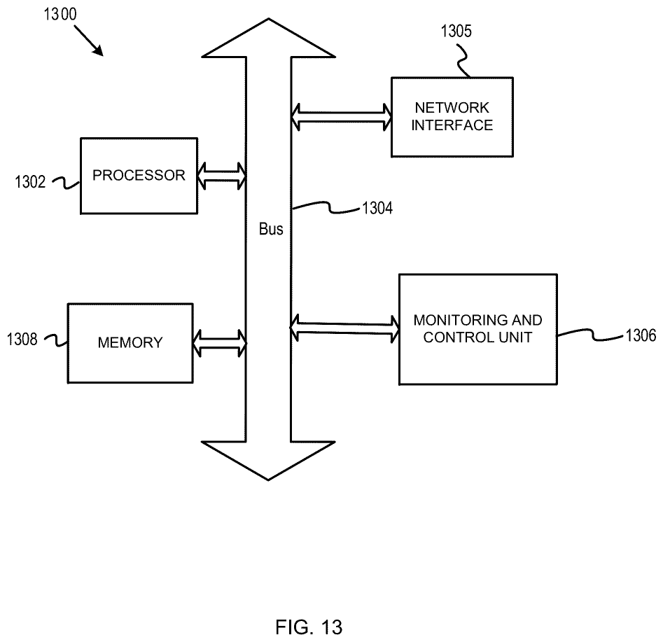

In some implementations, hardware and/or machine instructions for performing the operations described herein are implemented via a computer system. FIG. 13 is a block diagram illustrating a computer system configured to determine statistical metrics from well communications and facilitate corrective actions. In FIG. 13, the computer system 1300 may include one or more processors 1302 connected to a system bus 1304. The system bus 1304 may be connected to memory 1308 and a network interface 1305. The memory 1308 may include any suitable memory random access memory (RAM), non-volatile memory (e.g., magnetic memory device), and/or any device for storing information and instructions executable by the processor(s) 1302. The network interface 1305 may provide connectivity to any suitable network, such as a wired network, wireless network, satellite network, etc.

The computer system 1300 may include additional peripheral devices. For example, the computer system 1300 may include multiple external multiple processors. In some implementations, any of the components may be integrated or subdivided.

The computer system 1300 also may include a monitoring and control unit 1306 configured to perform operations for determining z-sores, LVI, CVI, and/or any other statistical metrics related to real-time communications and data collection (as described herein). The monitoring and control unit 1306 also may facilitate corrective actions to equipment at a wellsite. For example, the monitoring and control unit 1306 may detect statistical anomalies (such as using LVI and CVI) with a well system. Some implementations may interpret such anomalies based on rig state (as described herein). Some implementations may cause physical changes to wellsite equipment such as by notifying wellsite operators who may change a downhole sensor, reconfigure the downhole sensor, or performing other operations that physically modifies equipment. Some implementations may not need operators to physically modify equipment, as they may include autonomous means for modifying equipment. In some implementations the monitoring and control unit 1306 can perform any combination of the operations described herein. In some implementations, the computer system 1300 may be included in a well system and may cooperate with other components and/or systems to perform the functionality described herein.

Although the components are shown separately, any of the components of the computer system 1300 may be further combined or subdivided. Any component of the computer system 1300 may be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

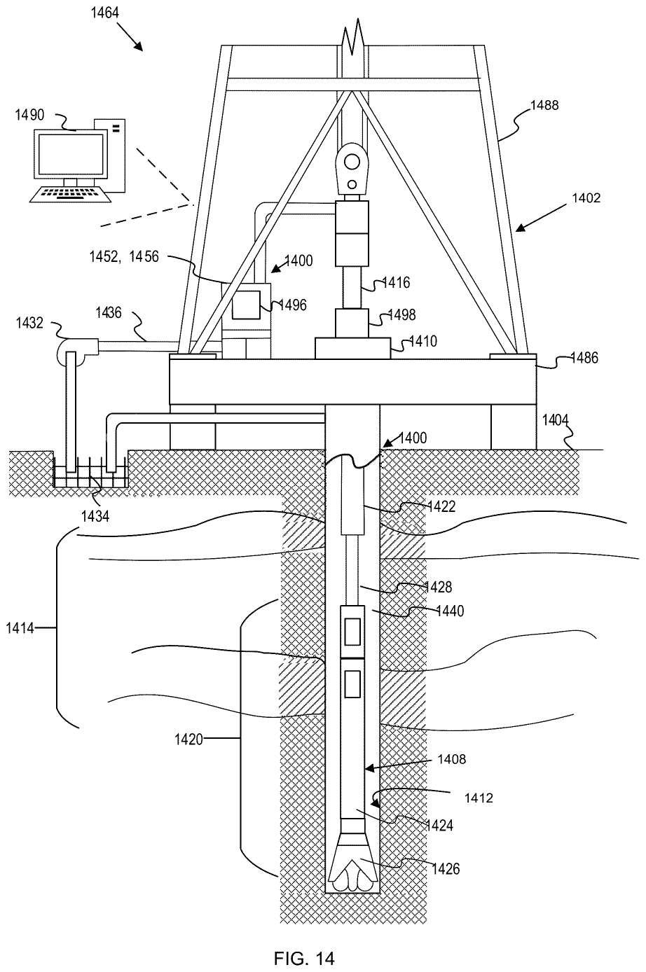

In some implementations, the monitoring and control unit 1306 may monitor real-time communications and/or information collected by field-based components (such as sensors, tools, machines, and more). For example, the monitoring and control unit 1306 may cooperate with a drilling system. FIG. 14 is a schematic diagram of a drilling system. The drilling system 1464 may include at least a portion of a drilling rig 1402 located at the surface 1404 of a well 1406. Drilling of oil and gas wells is commonly conducted using a string of drill pipes connected to form a drilling string 1408 that may be lowered through a rotary table 1410 into a wellbore or borehole 1412. Here a drilling platform 1486 may be equipped with a derrick 1488 that supports a hoist.

A computer system 1490 may be used to control one or more operations of the drilling system 1464. The computer system 1490 may be communicatively connected to the computer system 1300. The computer system 1490 may transmit information related to operations (such as sensor readings, tool orientations, flow rates, and any other suitable information collected at the drilling system 1464) to the computer system 1300. Alternatively, the computer system 1300 may have real-time access to information collected by or information transmitted from the computer system 1490.

The drilling rig 1402 may thus provide support for the drill string 1408. The drill string 1408 may operate to penetrate the rotary table 1410 for drilling the borehole 1412 through subsurface formations 1414. The drill string 1408 may include a Kelly 1416, drill pipe 1418, and a bottom hole assembly 1420, perhaps located at the lower portion of the drill pipe 1418.

The bottom hole assembly 1420 may include drill collars 1422, a down hole tool 1424, and a drill bit 1426. The drill bit 1426 may operate to create a borehole 1412 by penetrating the surface 1404 and subsurface formations 1414. The down hole tool 1424 may comprise any of a number of different tool types including MWD tools, LWD tools, and others.

During drilling operations, the drill string 1408 (such as including the Kelly 1416, the drill pipe 1418, and the bottom hole assembly 1420) may be rotated by the rotary table 1410. In addition to, or alternatively, the bottom hole assembly 1420 may also be rotated by a motor (e.g., a mud motor) that may be located down hole. The drill collars 1422 may be used to add weight to the drill bit 1426. The drill collars 1422 may also operate to stiffen the bottom hole assembly 1420, allowing the bottom hole assembly 1420 to transfer the added weight to the drill bit 1426, and in turn, to assist the drill bit 1426 in penetrating the surface 1404 and subsurface formations 1414.

During drilling operations, a mud pump 1432 may pump drilling fluid (sometimes known by those of ordinary skill in the art as “drilling mud”) from a mud pit 1434 through a hose 1436 into the drill pipe 1418 and down to the drill bit 1426. The drilling fluid may flow out from the drill bit 1426 and be returned to the surface 1404 through an annular area 1440 between the drill pipe 1418 and the sides of the borehole 1412. The drilling fluid may then be returned to the mud pit 1434, where such fluid may be filtered. In some embodiments, the drilling fluid may be used to cool the drill bit 1426, as well as to provide lubrication for the drill bit 1426 during drilling operations. Additionally, the drilling fluid may be used to remove subsurface formation 1414 cuttings created by operating the drill bit 1426. It may be the images of these cuttings that many implementations operate to acquire and process.

The drilling system 1464 may drill horizontal wellbores for use with hydraulic fracturing and other operations. During such operations, the plug assembly 1400 and set tool may be deployed to isolate a segment of the wellbore. Any of the components described herein and other components may be used to facilitate operations involving the plug assembly 1400 and set tool (such as to insert, remove, activate, and/or deactivate the plug assembly 1400 in the wellbore).

Although the monitoring and control unit 1306 may cooperate with a drilling system, some implementations of the monitoring and control unit 1306 may cooperate with any suitable production equipment.

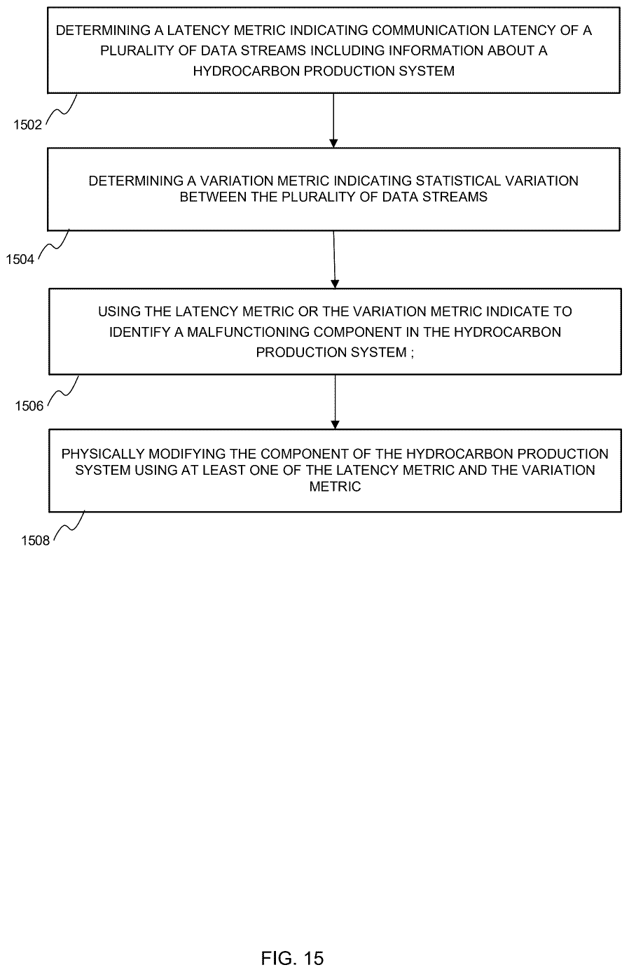

FIG. 15 is a flow diagram illustrating a method for monitoring real-time data and taking corrective action to remedy problems in a hydrocarbon production system. In FIG. 15, at block 1502, the monitoring and control unit 1306 determines a latency metric indicating communication latency of a plurality of data streams including information about a hydrocarbon production system. At block 1504, the monitoring and control unit 1306 determines a variation metric indicating statistical variation between the plurality of data streams. At block 1504, the monitoring and control unit 1306 uses the latency metric or the variation metric indicate to identify a malfunctioning component in the hydrocarbon production system. At block 1506, the monitoring and control unit 1306 physically modifies the component of the hydrocarbon production system using at least one of the latency metric and the variation metric.

FIGS. 1-15 and the operations described herein are examples meant to aid in understanding example implementations and should not be used to limit the potential implementations or limit the scope of the claims. None of the implementations described herein may be performed exclusively in the human mind nor exclusively using pencil and paper. None of the implementations described herein may be performed without computerized components such as those described herein. Some implementations may perform additional operations, fewer operations, operations in parallel or in a different order, and some operations differently. Some implementations may perform the operations with different components.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits, and algorithm processes described in connection with the implementations disclosed herein may be implemented as electronic hardware, computer software, or combinations of both. The interchangeability of hardware and software has been described in terms of functionality, and illustrated in the various illustrative components, blocks, modules, circuits and processes described throughout. Whether such functionality is implemented in hardware or software depends upon the particular application and design constraints imposed on the overall system.

The hardware and data processing apparatus used to implement the various illustrative logics, logical blocks, modules and circuits described in connection with the implementations disclosed herein may be implemented or performed with a general purpose single-or multi-chip processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor may be a microprocessor or any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more implementations, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, such as one or more modules of computer program instructions stored on a computer storage media for execution by, or to control the operation of, a computing device.

If implemented in software, the functions may be stored on or transmitted over as one or more instructions or code on a computer-readable medium. The processes of a method or algorithm disclosed herein may be implemented in a processor-executable instructions which may reside on a computer-readable medium. Computer-readable media includes both computer storage media and communication media including any medium that may be enabled to transfer a computer program from one place to another. Storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-Ray™ disc where disks usually reproduce data magnetically, while discs reproduce data optically with lasers. Combinations also may be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be removed from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may be integrated together in a single software product or packaged into multiple software products. Additionally, other implementations are within the scope of the following claims. In some cases, the actions recited in the claims may be performed in a different order and still achieve desirable results.

Implementations may be described by the following clauses.
Clause 1: A method comprising: determining a latency metric indicating communication latency of a plurality of data streams including information about a hydrocarbon production system; determining a variation metric indicating statistical variation between the plurality of data streams; using the latency metric or the variation metric to identify a malfunctioning component in the hydrocarbon production system; and physically modifying the component of the hydrocarbon production system using at least one of the latency metric and the variation metric.
Clause 2: The method of clause 1, wherein determining the latency metric includes computing a z-score for average latency across the plurality of data streams.
Clause 3: The method of any one or more of clauses 1-2, wherein determining the latency metric further includes: determining z-scores for latency for each of the plurality of data streams; determining a standard deviation of the z-scores for latency for each of the plurality of data streams; and dividing the z-score for average latency across the plurality of data streams by the standard deviation of the z-scores for latency for each of the plurality of data streams.
Clause 4: The method of any one or more of clauses 1-3, wherein each of the standard deviations of the z-scores for latency are determined over a specified time window.
Clause 5: The method of any one or more of clauses 1-4, wherein determining the variation metric includes: determining a z-score for variation for each of the plurality of data streams; and determining a maximum z-score and minimum z-score from the z-scores for variation for each of the plurality of data streams.
Clause 6: The method of any one or more of clauses 1-5, wherein determining the variation metric further includes: dividing a difference between the maximum z-score and the minimum z-score by a standard deviation of the z-scores for variation.
Clause 7: The method of any one or more of clauses 1-6, wherein the standard deviation of the z-scores for variation are determined over a specified time window.
Clause 8: The method of any one or more of clauses 1-7 further comprising: determining activity at the hydrocarbon production system; and using the activity with the latency metric or the variation metric to identify the malfunctioning component in the hydrocarbon production system.
Clause 9: The method of any one or more of clauses 1-8 further comprising: determining activity at the hydrocarbon production system; and ignoring one of the latency metric and the variation metric in response to the activity metric.
Clause 10: The method of any one or more of clauses 1-9, wherein the plurality of data streams include information about the component of the hydrocarbon production system.
Clause 11: The method of any one or more of clauses 1-10, wherein the component is one of a sensor, downhole tool, drill bit, and pump.
Clause 12: A method comprising: determining a first metric indicating a first statistical property of one or more of a plurality of data streams that include information about a hydrocarbon production system; determining a second metric indicating a second statistical property of one or more of the plurality of data streams; using the first metric or the second metric to identify a malfunctioning component in the hydrocarbon production system; and physically modifying the component of the hydrocarbon production system using at least one of the first metric and the second metric.
Clause 13: The method of clause 12, wherein the first metric and second metric are selected from a list of metrics including: a latency metric indicating communication latency of a plurality of data streams; a variation metric indicating statistical variation between the plurality of data streams; a frequency metric indicating a statistical communication latency of a plurality of data streams; and a value metric indicating statistical variation between data values in the plurality of data streams.
Clause 14: The method of any one or more of clauses 12-13, wherein determining the value metric includes: determining a data value for each data item received in each respective data stream; determining a first average of the data values in a first stream of the data streams; determining a second average of the data values in all the data streams; and comparing each data value to the first average and the second average.
Clause 15: A system comprising: one or more processors; one or more computer-readable mediums including instructions executable by the one or more processors, the instructions including: instructions to determine a latency metric indicating communication latency of a plurality of data streams including information about a hydrocarbon production system; instructions to determine a variation metric indicating statistical variation between the plurality of data streams; instructions to use the latency metric or the variation metric to identify a malfunctioning component in the hydrocarbon production system; and instructions to physically modify the component of the hydrocarbon production system using at least one of the latency metric and the variation metric.

Clause 16: The system of clause 15, wherein the instructions to determine the latency metric include instructions to compute a z-score for average latency across the plurality of data streams.

Clause 17: The system of any one or more of clauses 15-16, wherein determining the latency metric further includes: determining z-scores for latency for each of the plurality of data streams; determining a standard deviation of the z-scores for latency for each of the plurality of data streams; and dividing the z-score for average latency across the plurality of data streams by the standard deviation of the z-scores for latency for each of the plurality of data streams.

Clause 18: The system of any one or more of clauses 15-17, wherein each of the standard deviations of the z-scores for latency are determined over a specified time window.

Clause 19: The system of any one or more of clauses 15-18, wherein determining the variation metric includes: determining a z-score for variation for each of the plurality of data streams; and determining a maximum z-score and minimum z-score from the z-scores for variation for each of the plurality of data streams.

Clause 20: The system of any one or more of clauses 15-19, wherein determining the variation metric further includes: dividing a difference between the maximum z-score and the minimum z-score by a standard deviation of the z-scores for variation.

What is claimed is:

1. A method comprising:
determining a latency metric indicating communication latency of a plurality of data streams including information about a hydrocarbon production system;
determining a variation metric indicating statistical variation between the plurality of data streams;
using the latency metric or the variation metric indicate to identify a malfunctioning component in the hydrocarbon production system ; and
physically modifying the component of the hydrocarbon production system using at least one of the latency metric and the variation metric.

2. The method of claim 1, wherein determining the latency metric includes computing a z-score for average latency across the plurality of data streams.

3. The method of claim 2, wherein determining the latency metric further includes:
determining a respective z-score for latency for each of the plurality of data streams;
determining a standard deviation for all the respective z-scores for latency;
dividing each respective z-score for latency by the standard deviation of all the respective z-scores.

4. The method of claim 3, wherein each of the standard deviations of the respective z-scores for latency are determined over a specified time window.

5. The method of claim 1, wherein determining the variation metric includes:
determining a z-score for variation for each of the plurality of data streams; and
determining a maximum z-score and minimum z-score from the z-scores for variation for each of the plurality of data streams.

6. The method of claim 5, wherein determining the variation metric further includes:
dividing a difference between the maximum z-score and the minimum z-score by a standard deviation of the z-scores for variation.

7. The method of claim 6, wherein the standard deviation of the z-scores for variation are determined over a specified time window.

8. The method of claim 1 further comprising:
determining activity at the hydrocarbon production system; and
using the activity with the latency metric or the variation metric to identify the malfunctioning component in the hydrocarbon production system.

9. The method of claim 1 further comprising:
determining activity at the hydrocarbon production system; and
ignoring one of the latency metric and the variation metric in response to the activity metric.

10. The method of claim 1, wherein the plurality of data streams include information about the component of the hydrocarbon production system.

11. The method of claim 10, wherein the component is one of a sensor, downhole tool, drill bit, and pump.

12. A method comprising:
determining a first metric indicating a first statistical property of one or more of a plurality of data streams that include information about a hydrocarbon production system;
determining a second metric indicating a second statistical property of one or more of the plurality of data streams;
using the first metric or the second metric to identify a malfunctioning component in the hydrocarbon production system; and
physically modifying the component of the hydrocarbon production system using at least one of the first metric and the second metric.

13. The method of claim 12, wherein the first metric and second metric are selected from a list of metrics including:
a latency metric indicating communication latency of a plurality of data streams;
a variation metric indicating statistical variation between the plurality of data streams;
a frequency metric indicating a statistical communication latency of a plurality of data streams; and
a value metric indicating statistical variation between data values in the plurality of data streams.

14. The method of claim 12, wherein determining the first metric includes:
determining a data value for each data item received in each respective data stream;
determining a first average of the data values in a first stream of the data streams;
determining a second average of the data values in all the data streams; and
comparing each data value to the first average and the second average.

15. A system comprising:
one or more processors;
one or more computer-readable mediums including instructions executable by the one or more processors, the instructions including
instructions to determine a latency metric indicating communication latency of a plurality of data streams including information about a hydrocarbon production system;
instructions to determine a variation metric indicating statistical variation between the plurality of data streams;
instructions to use the latency metric or the variation metric indicate to identify a malfunctioning component in the hydrocarbon production system ; and
instructions to physically modify the component of the hydrocarbon production system using at least one of the latency metric and the variation metric.

16. The system of claim 15, wherein the instructions to determine the latency metric include instructions to compute a z-score for average latency across the plurality of data streams.

17. The system of claim 16, wherein determining the latency metric further includes:
determining z-scores for average latency for each of the plurality of data streams;
determining a standard deviation of the z-scores for latency for each of the plurality of data streams;
dividing the z-score for average latency for each of the plurality of data streams by the standard deviation of the z-scores for latency for each of the plurality of data streams.

18. The system of claim 17, wherein each of the standard deviations of the z-scores for latency are determined over a specified time window.

19. The system of claim 15, wherein determining the variation metric includes:
determining a z-score for variation for each of the plurality of data streams; and
determining a maximum z-score and minimum z-score from the z-scores for variation for each of the plurality of data streams.

20. The system of claim 19, wherein determining the variation metric further includes:
dividing a difference between the maximum z-score and the minimum z-score by a standard deviation of the z-scores for variation.
